(19) United States
(12) Patent Application Publication
(10) Pub. No.: US 2017/0212698 A1
(43) Pub. Date: Jul. 27, 2017

(54) COMPUTING SYSTEM WITH CACHE STORING MECHANISM AND METHOD OF OPERATION THEREOF

(71) Applicant: Samsung Electronics Co., Ltd., Suwon-si (KR)

(72) Inventors: Varun Singh Bhadauria, Sunnvyale, CA (US); Kenneth Yip, Santa Clara, CA (US); Tejas Chopra, Sunnyvale, CA (US); Pradeep Bisht, Sunnyvale, CA (US)

(21) Appl. No.: 15/096,261

(22) Filed: Apr. 11, 2016

Related U.S. Application Data
(60) Provisional application No. 62/286,107, filed on Jan. 22, 2016.

(51) Int. Cl. G06F 3/06; G06F 12/08

(52) U.S. Cl. CPC G06F 3/0616; G06F 3/0659; G06F 3/0661; G06F 3/0673; G06F 12/0888; G06F 2212/1036; G06F 2212/214; G06F 2212/401

(57) ABSTRACT

A computing system includes: a host processor configured to: determine a compression possibility based on a data type; compress data based on the compression possibility; determine a caching possibility based on the data; execute a batch write request including multiple instances of a write request based on the caching possibility, a store capacity meeting or exceeding a store threshold, or a combination thereof; and a nonvolatile memory, coupled to the host processor, configured to store the data based on the batch write request.

### CROSS-REFERENCE TO RELATED APPLICATION(S)

This application claims the benefit of U.S. Provisional Patent Application Ser. No. 62/286,107 filed Jan. 22, 2016, and the subject matter thereof is incorporated herein by reference thereto.

### TECHNICAL FIELD

An embodiment of the present invention relates generally to a computing system, and more particularly to a system with cache storing mechanism.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for data retention to increase storage lifecycle.

Research and development in the existing technologies can take a myriad of different directions. Some have taken a memory hierarchy approach utilizing volatile and nonvolatile memory for operational performance and for prolonging storage lifecycle. However, available systems inefficiently depletes lifecycle of the storage.

Thus, a need still remains for a computing system with a cache storing mechanism for prolonging storage lifecycle. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### SUMMARY

An embodiment of the present invention provides an apparatus, including: a host processor configured to: determine a compression possibility based on a data type; compress data based on the compression possibility; determine a caching possibility based on the data; execute a batch write request including multiple instances of a write request based on the caching possibility, a store capacity meeting or exceeding a store threshold, or a combination thereof; and a nonvolatile memory, coupled to the host processor, configured to store the data based on the batch write request.

An embodiment of the present invention provides a method, including: determining a compression possibility based on a data type; compressing data based on the compression possibility; determining a caching possibility based on the data; executing a batch write request including multiple instances of a write request with a host processor based on the caching possibility, a store capacity meeting or exceeding a store threshold, or a combination thereof; and storing the data based on the batch write request for storing in a nonvolatile memory.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with a cache storing mechanism in an embodiment of the present invention.

FIG. 2 is a control flow for the computing system.

FIG. 3 is a control flow for the compression consideration module.

FIG. 4 is a control flow for the compressibility module.

FIG. 5 is a control flow for the cache possibility module.

FIG. 6 is a control flow for the write module.

FIG. 7 shows examples of the computing system as application examples with the embodiment of the present invention.

FIG. 8 is a flow chart of a method of operation of a computing system in an embodiment of the present invention.

### DETAILED DESCRIPTION

Embodiments improve the efficiency of writing data to a nonvolatile memory because the embodiments can execute a batch write request. The nonvolatile memory can represent an embedded multimedia card that can have a shallow input/output request queue depth. By collectively writing the data with the batch write request, the embodiments can eliminate the delays from numerous individual small write operations from having multiple instances of the write request. As a result, the embodiments can bypass the performance bottleneck from the shallow queue depth by executing the batch write request.

Embodiments improve the system performance of the nonvolatile memory because the embodiments can execute a batch write request. The nonvolatile memory including the NAND flash memory can only sustain finite number of write operations or program-erase cycles. By eliminating numerous individual small write operations from having multiple instances of the write request with the batch write request, the embodiments can extend the system utilization lifetime of the nonvolatile memory to store the data.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the various embodiments of the invention. However, it will be apparent that various embodiments may be practiced without these specific details. In order to avoid obscuring various embodiments, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings generally show similar orientations, this depiction in the figures is arbitrary for the most part. Generally, an embodiment can be operated in any orientation.

The term “module” referred to herein can include software, hardware, or a combination thereof in an embodiment of the present invention in accordance with the context in which the term is used. For example, the software can be machine code, firmware, embedded code, application software, or a combination thereof. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section, the modules are deemed to include hardware circuitry for the purposes and the scope of apparatus claims.

The modules in the following description of the embodiments can be coupled to one other as described or as shown. The coupling can be direct or indirect without or with, respectively, intervening items between coupled items. The coupling can be by physical contact or by communication between items.

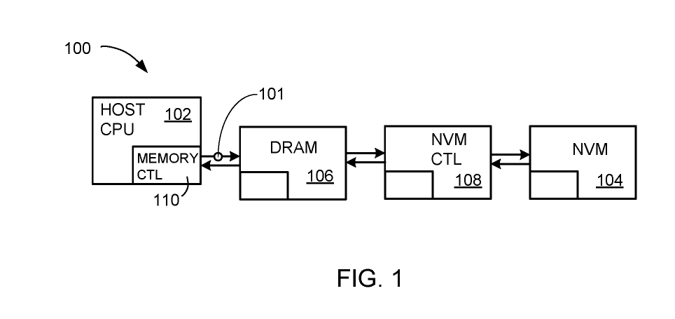

Referring now to FIG. 1, therein is shown a computing system 100 with a cache storing mechanism in an embodiment of the present invention. FIG. 1 depicts one embodiment of the computing system 100 where data 101 can be selectively stored. The term “selective storing” can refer to ability by the computing system 100 to compress and cache the data 101.

The computing system 100 can depict an embodiment where a host processor 102 can be (but need not be) on the same system board (not shown), such as a printed circuit board, a plug in card, or a mezzanine card, as a nonvolatile memory 104, a volatile memory 106, and a local memory controller 108. The host processor 102 can store the data 101 in the volatile memory 106, the nonvolatile memory 104, or a combination thereof.

The host processor 102 can include a host memory controller 110 for interacting with the volatile memory 106, the nonvolatile memory 104, the local memory controller 108, or a combination thereof. The host memory controller 110 provides protocol support for interacting with the volatile memory 106, the nonvolatile memory 104, the local memory controller 108, or a combination thereof.

Examples for the host processor 102 can include a general purpose microprocessor, a multi-core processor device, a digital signal processor (DSP), a field programmable gate array (FPGA), or an application specific integrated circuit (ASIC) with processing capability. Examples for the host memory controller 110 can include a random access memory (RAM) controller. The RAM can be volatile, such as a dynamic random access memory (DRAM) or a static random access memory (SRAM). The RAM can also be nonvolatile, such as a solid state flash memory.

The nonvolatile memory 104 can include the SRAM, an embedded multimedia card (eMMC), a solid-state storage device (SSD), or a combination thereof. The volatile memory 106 can include the DRAM, the SRAM, or a combination thereof. The volatile memory 106 can also function as a local cache to the computing system 100. More specifically as an example, the volatile memory 106 can include the DRAM cache to allow the execution of a command, such as read or write, to the DRAM cache instead of to the nonvolatile memory 104. Also for example, the volatile memory 106 can function as a cache for the data 101, instructions for execution by the computing system 100, or a combination thereof

The local memory controller 108 provides controls for the data 101 movement between the volatile memory 106 and the nonvolatile memory 104. The local memory controller 108 can be a nonvolatile memory controller, in this example.

For illustrative purposes, the computing system 100 is described with the host memory controller 110 and the local memory controller 108 as discrete elements, although it is understood that the computing system 100 can be configured and operated differently. For example, the host memory control 110 and the local memory controller 108 can be implemented within the same device or system, such as within the host processor 102 or with the system (not shown) housing the host processor 102. Also for example, the host memory control 110 and the local memory controller 108 can be implemented external to the host processor 102.

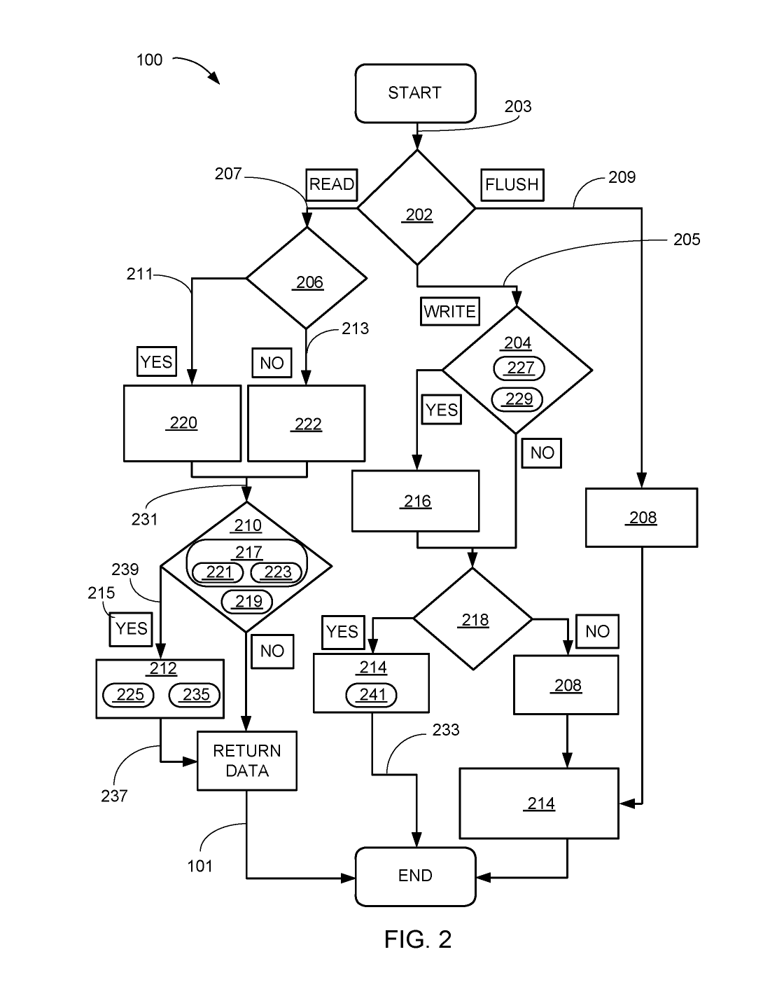

Referring now to FIG. 2, therein is shown a control flow for the computing system 100. The computing system 100 can include a command module 202. The command module 202 determines a request type 203. The request type 203 is a classification of a command requested by the computing system 100. For example, the request type 203 can include a write request 205, a read request 207, a flush request 209, or a combination thereof

The write request 205 can represent the command to request the data 101 to be written into the nonvolatile memory 104 of FIG. 1, the volatile memory 106 of FIG. 1, or a combination thereof. The read request 207 can represent a command to read the data 101 from the nonvolatile memory 104, the volatile memory 106, or a combination thereof. The flush request 209 can represent a command to flush the data 101 from the volatile memory 106.

The command module 202 can determine the request type 203 based on the data 101 including the command. If the request type 203 is determined as the write request 205, the command module 202 can transmit the data 101 to a compression consideration module 204. If the request type 203 is determined as the read request 207, the command module 202 can transmit the data 101 to a cache check module 206. If the request type 203 is determined as the flush request 209, the command module 202 can transmit the data 101 to a flush module 208.

The computing system 100 can include the cache check module 206, which can be coupled to the command module 202. The cache check module 206 determines whether there is a cache hit 211 or a cache miss 213. The cache hit 211 is a condition where the data 101 requested exists in the volatile memory 106, in this example serving as a memory cache. The cache miss 213 is a condition where the data 101 requested does not exist in the volatile memory 106. For example, the cache check module 206 can determine the cache hit 211, the cache miss 213, or a combination thereof based on the data 101 requested by the read request 207, the data 101 is in the volatile memory 106, or a combination thereof. For further example, the cache hit 211 can represent the condition where the data 101 requested exists in the DRAM cache. The cache check module 206 can transmit the determination of the cache hit 211 to a volatile storage read module 220. The cache check module 206 can transmit the determination of the cache miss 213 to a nonvolatile storage read module 222.

The computing system 100 can include the volatile storage read module 220, the nonvolatile storage read module 222, or a combination thereof, which can be coupled to the cache check module 206. The volatile storage read module 220 and the nonvolatile storage read module 222 provide the data 101 to the host processor 102. For example, the volatile storage read module 220 can read the data 101 from the volatile memory 106. For another example, the nonvolatile storage read module 222 can read the data 101 from the nonvolatile memory 104.

If the data 101 exists in the volatile memory 106 or is the cache hit 211, the volatile storage read module 220 can read the data 101 from the volatile memory 106. In contrast, if the data 101 does not exist in the volatile memory 106 or is the cache miss 213, the nonvolatile storage read module 222 can read the data 101 from the nonvolatile memory 104. For example, the data 101 can be read from the nonvolatile memory 104 representing a log-structured storage. The log-structured storage is an architecture where the storage of information or the data 101 is accessed as a circular buffer. The access can include read access, write access, or a combination thereof. The circular buffer functionality can be implemented with hardware circuitry, software, or a combination thereof. The log-structured storage can be implemented utilizing a head and a tail of the circular buffer to keep track of how much storage capacity is utilized, to avoid storage capacity overruns, and to reclaim storage capacity space.

The computing system 100 can include a compression determinator module 210, which can be coupled to the volatile storage read module 220, the nonvolatile storage read module 222, or a combination thereof. The compression determinator module 210 determines a compression status 215. The compression status 215 is a condition of whether the data 101 is compressed or not.

For a specific example, the compression determinator module 210 can determine the compression status 215 of compressed based on a type of compression algorithm used on the data 101. For a different example, the compression determinator module 210 can determine the compression status 215 based on a list type 217. The list type 217 is classification for a file 219 including the data 101 that should be compressed or not. The file 219 is a resource, unit, container for some amount of information or the data 101 contained therein.

For example, the list type 217 can include a white list 221, a black list 223, or a combination thereof. The white list 221 is a classification or type of information that should be compressed. The black list 223 is a classification or type of information that should not be compressed. For example, the file 219 can be included in the white list 221 or the black list 223.

If the file 219, the data 101, or a combination thereof is on the black list 223, the compression determinator module 210 can return the data 101 as is in response to the read request 207. For further example, if the data 101 is not compressed, thus the data 101 is not on the black list 223, the compression determinator module 210 can return the data 101 as is in response to the read request 207. If the data 101 is compressed, the compression determinator module 210 can transmit the data 101 to a decompression module 212.

The computing system 100 can include the decompression module 212, which can be coupled to the compression determinator module 210. The decompression module 212 recovers the data 101 back to a non-compressed form 237. The non-compressed form 237 is the data 101 without being compressed by the compression algorithm.

For example, the decompression module 212 can recover the data 101 back to the non-compressed form 237 based on a compression ratio 225, the compression algorithm used, or a combination thereof. The compression ratio 225 is a ratio between the non-compressed form 237 of the data 101 versus a compressed form 239 of the data 101. The compressed form 239 is the data 101 that has been compressed based on the compression algorithm.

For a specific example, the decompression module 212 can recover the data 101 that has been compressed back to the non-compressed form 237 according to the compression algorithm originally used along with the compression ratio 225 to compress the data 101. For further example, the decompression module 212 can recover the data 101 back to the non-compressed form 237 based on a decompression algorithm that matches with the compression algorithm used to compress the data 101.

More specifically as an example, if the compression ratio 225 is 5 to 1 where the non-compressed form 237 is 5 times larger in size than the compressed form 239, the decompression module 212 can recover the data 101 back to the non-compressed form 237 that is 5 times larger than the compressed form 239. For further example, the decompression module 212 can recover the data 101 back to the non-compressed form 237 based on the decompression algorithm, the compression ratio 225, or a combination thereof where the data 101 was previously compressed as part of processing the write request 205.

For a different example, the decompression module 212 can recover the data 101 based on the list type 217. For example, the decompression module 212 can recover the data 101 based on whether the file 219, the data 101, or a combination thereof is on the white list 221 or the black list 223. If the file 219, the data 101, or a combination thereof is on the white list 221, the decompression module 212 can recover the data 101 back to the non-compressed form 237.

More specifically as an example, the file 219 can include information or indexes to indicate a file type 235. The file type 235 is classification of the file 219. The information included in the file 219 can represent header information stored with the compressed form 239 of the data 101. The information can also represent file extension of the file 219. The information allows the computing system 100 to ascertain the file type 235 of the file 219 to group the file 219 into the list type 217.

Based on the file type 235 of the file 219, the decompression module 212 can ascertain whether the file 219, the data 101, or a combination thereof is in the white list 221 or the black list 223. As a result, the decompression module 212 can recover the data 101 based on the list type 217 to decompress the data 101 back to the non-compressed form 237. The decompression module 212 can return the data 101 that has been recovered in response to the read request 207.

The computing system 100 can include the flush module 208, which can be coupled to the command module 202. The flush module 208 synchronizes the data 101 with the data 101 in the volatile memory 106. For example, the flush module 208 can synchronize a dirty instance of the data 101 in the volatile memory 106. More specifically as an example, the flush module 208 can synchronize the dirty instance of the data 101 in the cache. The dirty instance of the data 101 can represent a situation where the data 101 in the volatile memory 106 is different from the same representation of the data 101 in the nonvolatile memory 104.

The flush module 208 can synchronize the data 101 in a number of ways. For example, if the data 101 in the volatile memory 106 is newer than the data 101 in the nonvolatile memory 104, the flush module 208 can update the data 101 in the nonvolatile memory 104 to the data 101 in the volatile memory 106. For a different example, if the data 101 in the nonvolatile memory 104 is newer than the data 101 in the volatile memory 106, the flush module 208 can update the data 101 in the volatile memory 106 to the data 101 in the nonvolatile memory 104.

Once the data 101 has been synchronized, the flush module 208 can transmit the data 101 to the nonvolatile memory 104. More specifically as an example, the flush module 208 can transmit the data 101 to a write module 214.

The computing system 100 can include the compression consideration module 204, which can be coupled to the command module 202. The compression consideration module 204 determines a compression possibility 227. For example, the compression consideration module 204 can determine the compression possibility 227 based on a data type 229 of the data 101. The compression possibility 227 is a determination whether the data 101 is compressible. The data type 229 is a classification of the data 101. Details regarding the compression consideration module 204 will be discussed below.

The compression consideration module 204 can transmit the data 101 to a compression execution module 216, a cache possibility module 218, or a combination thereof based on the compression possibility 227. For example, if the compression possibility 227 represents “no,” the data 101 is not compressible. As a result, the compression consideration module 204 can transmit the data 101 to the cache possibility module 218. Details will be discussed below. In contrast, if the compression possibility 227 represents “yes,” the data 101 is compressible. As a result, the compression consideration module 204 can transmit the data 101 to the compression execution module 216.

The computing system 100 can include the compression execution module 216, which can be coupled to the compression consideration module 204. The compression execution module 216 compresses the data 101. For example, the compression execution module 216 can compress the data 101 based on the compression possibility 227. More specifically as an example, if the compression possibility 227 represents “true,” the data 101 is compressible.

For further example, the compression execution module 216 can compress the data 101 by converting the non-compressed form 237 of the data 101 into the compressed form 239 of the data 101 where less storage capacity is required in the nonvolatile memory 104, the volatile memory 106, or a combination thereof. More specifically as an example, the compression execution module 216 can compress the data 101 according to the compression ratio 225. If the compression ratio 225 is 10:1, the compression execution module 216 can compress the non-compressed form 237 of the data 101 into one tenth of the original size. The compression ratio 225 can be defined in the compression algorithm.

The compression execution module 216 can be a submodule within the compression consideration module 204. Further detail regarding the compression execution module 216 will be discussed below. The compression execution module 216 can transmit the data 101 that has been compressed to the cache possibility module 218.

The computing system 100 can include the cache possibility module 218, which can be coupled to the compression consideration module 204, the compression execution module 216, or a combination thereof. The cache possibility module 218 determines a caching possibility 231. The caching possibility 231 is a determination whether the data 101 should be written to the volatile memory 106 or not. For example, the cache possibility module 218 can determine the caching possibility 231 based on the data type 229. Details will be discussed below. The cache possibility module 218 can transmit the caching possibility 231 to the write module 214, the flush module 208, or a combination thereof.

The computing system 100 can include the write module 214, which can be coupled to the flush module 208, the cache possibility module 218, or a combination thereof. The write module 214 writes the data 101. For example, the write module 214 can write the data 101 to the volatile memory 106. More specifically as an example, the write module 214 can write the data 101 to the DRAM cache based on the caching possibility 231 representing “true.”

For another example, the write module 214 can execute a batch write request 205 of the data 101. The batch write request 233 is a command to write the data 101 in a batch rather than one instance of the write request 205 at a time. The batch or batching can represent a group of random instances of the write request 205.

More specifically as an example, “batching” in the context can mean grouping of random reads and writes to minimize access to the nonvolatile memeory 104. Although Read is not affected as much as other than access time, Write is most affected where an erase needs to occur before a program cycle can occur.

The program cycles is the actual writing of the data 101 into the nonvolatile memeory 104. As a result, although the access of the data 101 to be written one bit or one bank at a time may be the same, each write can use up the endurance or lifecycle of the nonvolatile memeory 104. For example, the write module 214 can store the data 101 in the volatile memory 106 until the batch is full or a store capacity 431 is full prior to writing to the nonvolatile memory 104. The store capacity 431 is amount of information that can be stored. For example, the nonvolatile memory 104, the volatile memory 106, or a combination thereof can include the store capacity 431.

For further example, the batch can be full when the computing system 100 is idle for a predefined time period, the store capacity 431 of the volatile memory 106 has met or exceeded a store threshold 433, the flush request 209 has been received, or a combination thereof. The store threshold 433 is a capacity limit of the storage device. For example, the store threshold 431 can represent a minimum capacity of the nonvolatile memory 104, the volatile memory 106, or a combination thereof. For another example, the store threshold 433 can represent a maximum capacity of the nonvolatile memory 104, the volatile memory 106, or a combination thereof

It has been discovered that the computing system 100 executing the batch write request 233 improves the efficiency of writing the data 101 to the nonvolatile memory 104. For example, the nonvolatile memory 104 representing the eMMC can have a shallow input/output (I/O) request queue depth. By collectively writing the data 101 with the batch write request 233, the computing system 100 can eliminate the delays from numerous individual small write operations from having multiple instances of the write request 205. As a result, the computing system 100 can bypass the performance bottleneck from the shallow queue depth by executing the batch write request 233.

It has been further discovered that the computing system 100 executing the batch write request 233 improves the performance of the nonvolatile memory 104. The nonvolatile memory 104 including the NAND flash memory can only sustain a finite number of write operations. By eliminating numerous individual small write operations from having multiple instances of the write request 205 with the batch write request 233, the computing system 100 can extend the lifetime of the nonvolatile memory 104 to store the data 101.

For illustrative purposes, the computing system 100 is described with the flush module 208 synchronizing the dirty instance of the data 101, although it is understood that the flush module 208 can operate differently. For example, the flush module 208 can synchronize the data 101 with the caching possibility 231 representing “false.” More specifically as an example, the flush module 208 can synchronize the data 101 and invalidate the data 101 in the volatile memory 106.

As discussed above, the data 101 in the volatile memory 106 can be different from the data 101 in the nonvolatile memory 104. More specifically as an example, the data 101 in the volatile memory 106 can be not up to date compare to the nonvolatile memory 106. As a result, the flush module 208 can synchronize the data 101 in the volatile memory 106 by updating to the data 101 in the nonvolatile memory 104. For further example, the flush module 208 can invalidate the data 101 previously stored in the volatile memory 106 as being out of date. The flush module 208 can transmit the data 101 to the write module 214.

For illustrative purposes, the computing system 100 is described with the write module 214 writing the data 101 with the caching possibility 231 representing “true,” although it is understood that the write module 214 can operate differently. For example, the write module 214 can write the data 101 with the caching possibility 231 representing “false.” More specifically as an example, the write module 214 can write the data 101 to the nonvolatile memory 104 representing a log-structured storage based on the caching possibility 231 representing “false.”

The host processor 102 can execute the modules discussed above and below to perform the functions discussed. For example, the host processor 102 can execute the command module 202 to determine the request type 203. For another example, the host processor 102 can execute the compression consideration module 204 to determine the compression possibility 227. For a different example, the host processor 102 can execute the cache check module 206 to determine whether there is the cache hit 211, the cache miss 213, or a combination thereof.

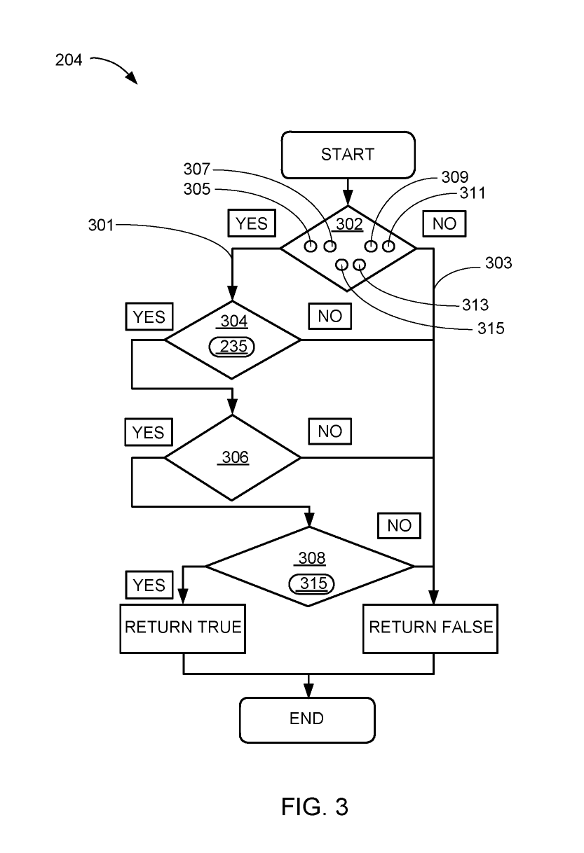

Referring now to FIG. 3, therein is shown a control flow for the compression consideration module 204. The compression consideration module 204 can include a type module 302. The type module 302 determines the data type 229 of FIG. 2. For example, the type module 302 can determine the data type 229 of the data 101 as a hot data 301, a cold data 303, or a combination thereof.

The hot data 301 can represent the data type 229 elevated or promoted for easier or faster access by the computing system 100 than the cold data 303. For example, the hot data 301 can be stored in the volatile memory 106 of FIG. 1 for quicker access than the cold data 303 stored in the nonvolatile memory 104 of FIG. 1. For further example, the hot data 301 can be demoted to become the cold data 303 and the cold data 303 can be promoted to become the hot data 301.

The type module 302 can determine the data type 229 in a number of ways. For example, the type module 302 can determine the data type 229 based on a storage location 305, a storage log 307, an access count 309, a data criticality 313, other metadata, or a combination thereof. The storage location 305 is a location where the data 101 is stored. For example, the storage location 305 can include the nonvolatile memory 104, the volatile memory 106, or a combination thereof

The access count 309 is a number of times the data 101 has been accessed. For example, the access count 309 can represent the number of times the data 101 has been accessed in the nonvolatile memory 104, the volatile memory 106, or a combination thereof. A count threshold 311 is a limit for number of times the data 101 has been accessed. The storage log 307 is a record of the data 101 being accessed. For example, the storage log 307 can indicate the time, the storage location 305, the access count 309, or a combination thereof of the data 101.

The data criticality 313 is a level of criticalness of the data 101. A criticality threshold 315 is a limit to determine the level of criticalness of the data 101. For example, the level of criticalness can represent the level of importance of the data 101. For further example, the criticality threshold 315 can represent a minimum level of importance required for the data 101 to be considered the hot data 301.

For a specific example, if the storage log 307 indicates that the data 101 has been accessed in the volatile memory 106, the type module 302 can determine the data type 229 to represent the hot data 301. For further example, if the access count 309 meets or exceeds the count threshold 311, the type module 302 can determine the data type 229 to represent the hot data 301. In contrast, the type module 302 can determine the data type 229 of the cold data 303 if the access count 309 is below the count threshold 311.

For another example, if the data criticality 313 of the data 101 meets or exceeds the criticality threshold 315, the type module 302 can determine the data type 229 to represent the hot data 301. In contrast, the type module 302 can determine the data type 229 of the cold data 303 if the data criticality 313 is below the criticality threshold 315. The type module 302 can transmit the data type 229 to a list module 304 if the data 101 is determined to be the hot data 301. The type module 302 can return “no” for whether the data 101 should be compressed if the data 101 is determined to be the cold data 303.

The compression consideration module 204 can include the list module 304, which can be coupled to the type module 302. The list module 304 determines the list type 217 of FIG. 2.

For example, the list module 304 can determine the list type 217 of the file 219 of FIG. 2 based on the file type 235. For a specific example, the file type 235 can be classified by the file extension of the file 219. The list module 304 can determine whether the file 219 should be in the white list 221 of FIG. 2 or the black list 223 of FIG. 2 based on the file type 235 of the file 219.

For a specific example, the file type 235 can represent the file 219 for an image, video, audio, or a combination thereof. The file 219 for the image, video, audio, or a combination thereof can be relatively difficult to compress. As a result, the list module 304 can determine the file 219 to belong on the black list 223. In contrast, if the file 219 that is not the image, video, audio, or a combination thereof, the list module 304 can determine the file 219 to belong on the white list 221, as it may be easier to compress. If the file 219 is determined to belong on the white list 221, the list module 304 can transmit the file 219 to a process module 306. If the file 219 is determined to belong on the black list 223, the list module 304 can return “no” for whether the file 219 and the data 101 should be compressed.

The compression consideration module 204 can include the process module 306, which can be coupled to the list module 304. The process module 306 groups the file 219. For example, the process module 306 can group multiple instances of the file 219 based on the list type 217. More specifically as an example, the process module 306 can group multiple instances of the file 219 that belong in the white list 221. The process module 306 can group multiple instances of the file 219 that belong in the black list 223. If the multiple instances of the file 219 from the white list 221 are grouped, the process module 306 can transmit the multiple instances of the file 219 that were grouped to a compressibility module 308. If the multiple instances of the file 219 from the black list 223 are grouped, the process module 306 can return “no” for whether the file 219 and the data 101 should be compressed.

[The compression consideration module 204 can include the compressibility module 308, which can be coupled to the process module 306. The compressibility module 308 determines a compressibility 315 of the file 219. The compressibility 315 is a condition where the file 219, the data 101, or a combination thereof is compressible. For example, the compressibility module 308 can determine the compressibility 315 based on whether the file 219 can be compressed. Details regarding the compressibility module 308 will be discussed below.

The compression consideration module 204 can return “true” if the file 219 can be compressed. In contrast, the compression consideration module 204 can return “false” if the modules of the compression consideration module 204 return “no.”

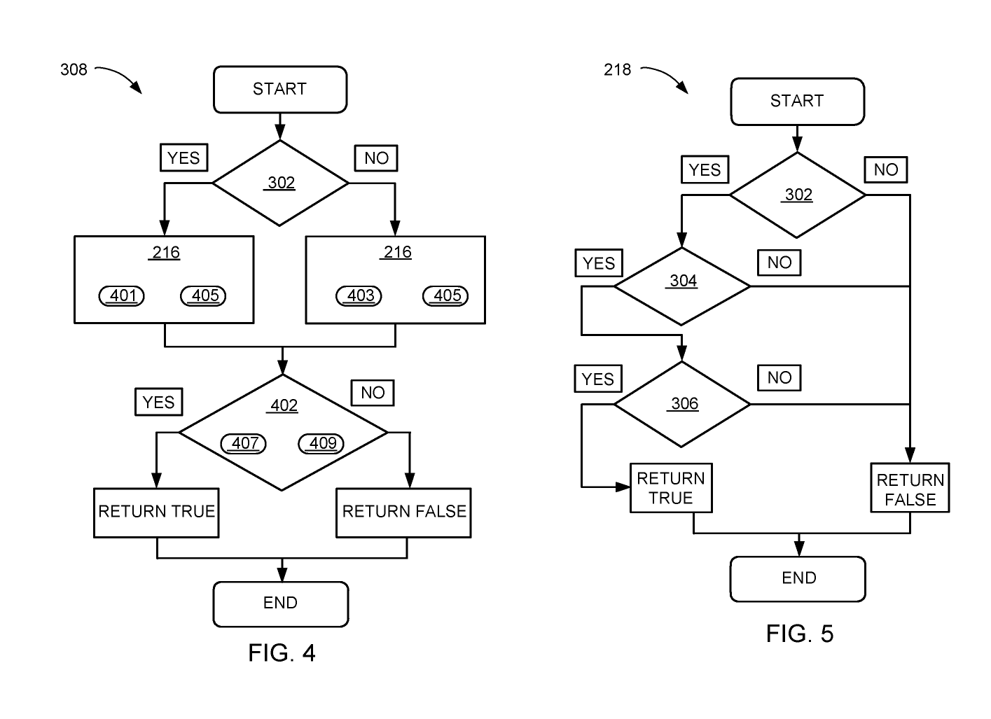

Referring now to FIG. 4, therein is shown a control flow for the compressibility module 308. The compressibility module 308 can include the type module 302. The type module 302 can determine whether the data type 229 of FIG. 2 of the data 101 in the file 219 of FIG. 2 is the hot data 301 of FIG. 3 or the cold data 303 of FIG. 3. The type module 302 can determine the data type 229 as discussed above in FIG. 3. Once the data type 229 is determined, the type module 302 can transmit the data 101 to the compression execution module 216.

The compressibility module 308 can include the compression execution module 216, which can be coupled to the type module 302. The compression execution module 216 compresses the file 219, the data 101, or a combination thereof. For example, the compression execution module 216 can compress the file 219, the data 101, or a combination thereof based on the data type 229. For further example, the compression execution module 216 can compress the file 219, the data 101, or a combination thereof as discussed above.

For further example, the compression execution module 216 can select the compression ratio 225 of FIG. 2 by selecting the compression algorithm based on the data type 229. The compression ratio 225 can include a high compression ratio 401 or a low compression ratio 403. The high compression ratio 401 can represent the compression ratio 225 meeting or exceeding a ratio threshold 405. The low compression ratio 403 can represent the compression ratio 225 below the ratio threshold 405. The ratio threshold 405 is a limit of the compression ratio 225 required.

For example, the compression execution module 216 can select the compression algorithm with the high compression ratio 401 to compress the cold data 303. The compression execution module 216 can select the compression algorithm with the high compression ratio 401 to compress the cold data 303 because the cold data 303 is infrequently accessed, thus, does not require recovery of the data 101 frequently or quickly.

In contrast, the compression execution module 216 can select the compression algorithm with the low compression ratio 403 for the hot data 301. More specifically as an example, since the hot data 301 can be frequently accessed, the high compression ratio 401 can delay the access of the hot data 301. As a result, the compression execution module 216 can select the compression algorithm with the low compression ratio 403 for the hot data 301 where the low compression ratio 403 is below the ratio threshold 405 or even zero to represent no compression.

For different example, the compression execution module 216 can select the compression algorithm for the compression ratio 225 meeting or exceeding the ratio threshold 405. The compression ratio 225 can differ for each type of compression algorithm. More specifically as an example, the compression ratio 225 for one type of the compression algorithm can be higher than another type of the compression algorithm. For a different example, one type of the compression algorithm can be more suited to compress the data type 229 than another type of the compression algorithm. If the compression ratio 225 is below the ratio threshold 405, the compression execution module 216 can select another instance of the compression algorithm so that the compression ratio 225 can meet or exceed the ratio threshold 405. The compression execution module 216 can transmit the file 219, the data 101, or a combination thereof to a compression check module 402.

The compressibility module 308 can include the compression check module 402, which can be coupled to the compression execution module 216. The compression check module 402 determines a compression result 407. For example, the compression check module 402 can determine the compression result 407 of achieving necessary compression level based on if the file 219, the data 101, or a combination thereof met or exceeded a compression threshold 409.

The compression result 407 is an outcome of the file 219, the data 101, or a combination thereof being compressed. The compression threshold 409 is a degree of compression level required in order for the file 219, the data 101, or a combination thereof to be determined to have achieved the necessary compression level. For example, the compression result 407, the compression threshold 409, or a combination thereof for the hot data 301 versus the cold data 303 can be different.

For further example, the compression threshold 409 can represent 50 percent of the non-compressed form 237. If the size of the compressed form 239 of the data 101 remains 50 percent or larger than the non-compressed form 237, the compression result 407 can be less than the compression threshold 409. The compressibility module 308 can determine the compression result 407 of not achieving the necessary compression level. In contrast, if the size of the compressed form 239 of the data 101 is less than 50 percent of the non-compressed form 237, the compression result 407 can be equivalent or more than the compression threshold 409. The compressibility module 308 can determine the compression result 407 of achieving the necessary compression level.

The compression check module 402 can determine the compressibility 315 of FIG. 3 of “true” if the compression result 407 meets or exceeds the compression threshold 409. In contrast, the compression check module 402 can determine the compressibility 315 of “false” if the compression result 407 is below the compression threshold 409.

Referring now to FIG. 5, therein is shown a control flow for the cache possibility module 218. The cache possibility module 218 can include the type module 302. The type module 302 can determine whether the data type 229 of FIG. 2 of the data 101 in the file 219 of FIG. 2 is the hot data 301 of FIG. 3 or the cold data 303 of FIG. 3. The type module 302 can determine the data type 229 as discussed above in FIG. 3. The type module 302 can transmit the data type 229 to the list module 304 if the data 101 is determined to be the hot data 301. The type module 302 can return “no” for whether the data 101 should be compressed if the data 101 is determined to be the cold data 303.

The cache possibility module 218 can include the list module 304, which can be coupled to the type module 302. The list module 304 can determine the list type 217 of FIG. 2 of the file 219 as discussed in FIG. 3. If the file 219 is determined to belong in the white list 221 of FIG. 2, the list module 304 can transmit the file 219 to the process module 306. If the file 219 is determined to belong in the black list 223 of FIG. 2, the list module 304 can return “no” for whether the file 219 and the data 101 should be cached.

The cache possibility module 218 can include the process module 306, which can be coupled to the list module 304. The process module 306 can group the file 219 as discussed in FIG. 3. If the multiple instances of the file 219 from the white list 221 are grouped, the process module 306 can determine the multiple instances of the file 219 to be stored in the volatile memory 106 of FIG. 1 and return “true.” If the multiple instances of the file 219 from the black list 223 are grouped, the process module 306 can return “no” for whether the file 219 and the data 101 should be stored in the volatile memory 106.

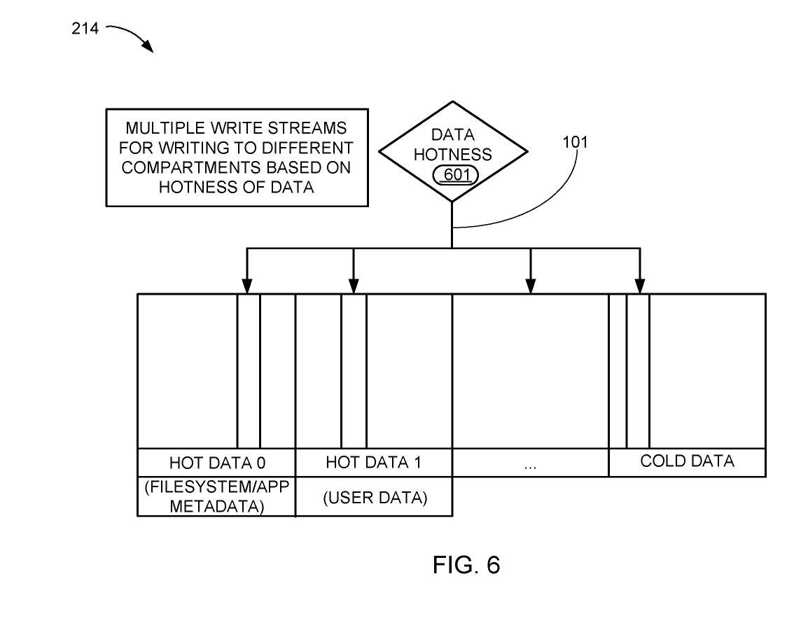

Referring now to FIG. 6, therein is shown a control flow for the write module 214. The write module 214 can write the data 101 based on the data type 229 of FIG. 2. For example, the write module 214 can write the data 101 based on the data type 229 to the nonvolatile memory 104 of FIG. 1, the volatile memory 106 of FIG. 1, or a combination thereof. More specifically as an example, the write module 214 can write the data 101 based on a hotness 601 of the data 101.

The hotness 601 is a level of ease in access of the data 101. For example, the hot data 301 of FIG. 3 can include multiple levels of the hotness 601 to indicate different levels for ease of access within different types of the hot data 301. For a specific example, the hot data 301 can include the data type 229 representing filesystem/app metadata, a user data, or a combination thereof. The filesystem metadata can have a higher degree of the hotness 601 than the user data. As a result, the filesystem metadata can be accessed more quickly than the user data. For a different example, the cold data 303 of FIG. 3 can include multiple levels of the hotness 601 to indicate different level for difficulty of access within different types of the cold data 303.

For a specific example, the write module 214 can write the data 101 into different instances of a compartment 603 within the nonvolatile memory 104, the volatile memory 106, or a combination thereof. The compartment 603 can represent the memory or storage address within the nonvolatile memory 104, the volatile memory 106, or a combination thereof. For example, multiple instances of the compartment 603 can be categorized to store different instances of the data 101 according to the hotness 601. The compartment 603 storing the hottest instance of the hotness 601 can allow the computing system 100 to access the data 101 the easiest or with the least latency. In contrast, the compartment 603 storing the coldest instance of the hotness 601 can allow the computing system 100 to access the data 101 with a greatest latency.

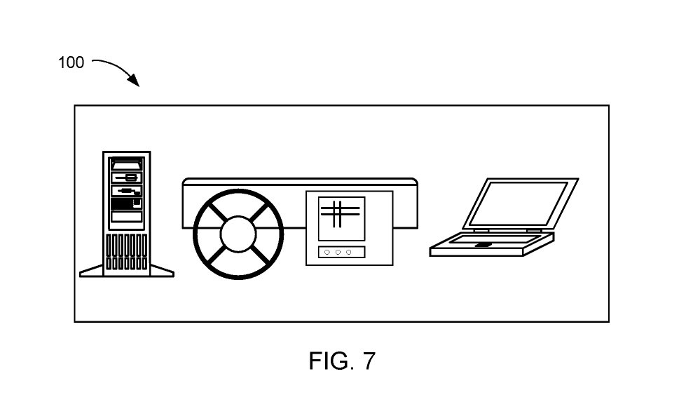

Referring now to FIG. 7, therein are shown examples of the computing system 100 as application examples with the embodiment of the present invention. FIG. 7 depicts various embodiments, as examples, for the computing system 100, such as a computer server, a dash board of an automobile, and a notebook computer.

These application examples illustrate the importance of the various embodiments of the present invention to provide improved efficiency of writing the data 101 of FIG. 1 to the nonvolatile memory 104 of FIG. 1. The cache storing mechanism can bypass the performance bottleneck from the shallow queue depth by executing the batch write request 233 of FIG. 2. This is accomplished by collectively writing the data 101 with the batch write request 233. Thus, the computing system 100 can eliminate the delays from numerous individual small write operations from having multiple instances of the write request 205.

The computing system 100, such as the computer server, the dash board, and the notebook computer, can include a one or more of a subsystem (not shown), such as a printed circuit board having various embodiments of the present invention or an electronic assembly having various embodiments of the present invention. The computing system 100 can also be implemented as an adapter card.

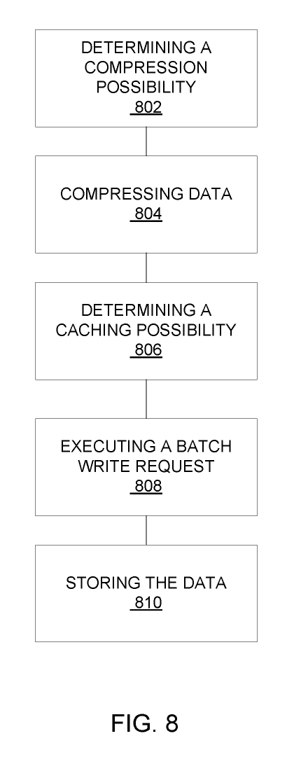

Referring now to FIG. 8, therein is a flow chart of a method of operation of a computing system 100 in an embodiment of the present invention. The method 1000 includes: determining a compression possibility based on a data type in a block 802; compressing data based on the compression possibility in a block 804; determining a caching possibility based on the data in a block 806; executing a batch write request including multiple instances of a write request with a host processor based on the caching possibility, a store capacity meeting or exceeding a store threshold, or a combination thereof in a block 808; and storing the data based on the batch write request for storing in a nonvolatile memory in a block 810.

The computing system 100 and the other embodiments have been described with module functions or order as an example. The computing system 100 can partition the modules differently or order the modules differently. For example, the type module 302 and the list module 304 can be combined.

The modules described in this application can be hardware implementation or hardware accelerators in the computing system 100 and in the other embodiments. The modules can also be hardware implementation or hardware accelerators within the computing system 100 or external to the computing system 100.

The modules described in this application can be implemented as instructions stored on a non-transitory computer readable medium to be executed by the computing system 100 or the other embodiments. The non-transitory computer medium can include memory internal to or external to the computing system 100. The non-transitory computer readable medium can include nonvolatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level. While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a host processor configured to:
determine a compression possibility based on a data type;
compress data based on the compression possibility;
determine a caching possibility based on the data;
execute a batch write request including multiple instances of a write request based on the caching possibility, a store capacity meeting or exceeding a store threshold, or a combination thereof; and
a nonvolatile memory, coupled to the host processor, configured to store the data based on the batch write request.

2. The system as claimed in claim 1 wherein the host processor is configured to write the data based on the caching possibility for storing the data in the nonvolatile memory.

3. The system as claimed in claim 1 wherein the host processor is configured to determine the compression possibility based on a list type including a white list, a black list, or a combination thereof.

4. The system as claimed in claim 1 wherein the host processor is configured to determine the compression possibility based on a hot data having quicker access than a cold data.

5. The system as claimed in claim 1 wherein the host processor is configured to select a compression ratio based on the data type for compressing the data.

6. The system as claimed in claim 1 wherein the host processor is configured to determine a compression result meeting or exceeding a compression threshold based on the data compressed.

7. The system as claimed in claim 1 wherein the host processor is configured to group multiple instances of a file based on a list type for determining whether the file is compressible.

8. The system as claimed in claim 1 wherein the nonvolatile memory is configured to write the data to a compartment based on a hotness of the data.

9. The system as claimed in claim 1 wherein the host processor is configured to recover the data from a compressed form into a non-compressed form based on the list type.

10. The system as claimed in claim 1 wherein the host processor is configured to synchronize the data based on the caching possibility for storing the data in the nonvolatile memory.

11. A method of operation of a computing system comprising:
determining a compression possibility based on a data type;
compressing data based on the compression possibility;
determining a caching possibility based on the data;
executing a batch write request including multiple instances of a write request with a host processor based on the caching possibility, a store capacity meeting or exceeding a store threshold, or a combination thereof; and
storing the data based on the batch write request for storing in a nonvolatile memory.

12. The method as claimed in claim 11 further comprising writing the data based on the caching possibility for storing the data in the nonvolatile memory.

13. The method as claimed in claim 11 wherein determining the compression possibility includes determining the compression possibility based on a list type including a white list, a black list, or a combination thereof.

14. The method as claimed in claim 11 wherein determining the compression possibility includes determining the compression possibility based on a hot data having quicker access than a cold data.

15. The method as claimed in claim 11 further comprising selecting a compression ratio based on the data type for compressing the data.

16. The method as claimed in claim 11 further comprising determining a compression result meeting or exceeding a compression threshold based on the data compressed.

17. The method as claimed in claim 11 further comprising grouping multiple instances of a file based on a list type for determining whether the file is compressible.

18. The method as claimed in claim 11 further comprising writing the data to a compartment based on a hotness of the data.

19. The method as claimed in claim 11 further comprising recovering the data from a compressed form into a non-compressed form based on the list type.

20. The method as claimed in claim 11 further comprising synchronizing the data based on the caching possibility for storing the data in the nonvolatile memory.
